(19) United States
(12) Patent Application Publication
(10) Pub. No.: US 2015/0199573 A1
(43) Pub. Date: Jul. 16, 2015

(54) Global Scene Descriptors for Matching Manhattan Scenes using Edge Maps Associated with Vanishing Points

(71) Applicant: Mitsubishi Electric Research Laboratories, Inc., Cambridge, MA (US)

(72) Inventors: Shantanu Rane, Cambridge, MA (US); Rohit Naini, Urbana, IL (US)

(73) Assignee: Mitsubishi Electric Research Laboratories, Inc., Cambridge, MA (US)

(21) Appl. No.: 14/151,962

(22) Filed: Jan. 10, 2014

(51) Int. Cl. G06K 9/00; G06T 7/00; G06K 9/46

(52) U.S. Cl. CPC G06K 9/00637; G06K 9/4642; G06T 7/0097

(57) ABSTRACT

A method constructs a descriptor for an image of a scene, wherein the descriptor is associated with a vanishing point in the image by first quantizing an angular region around the vanishing point into a preset number of angular quantization bins, and a centroid of each angular quantization bin indicates a direction of the angular quantization bin. For each angular quantization bin, a sum of magnitudes of pixel gradients for pixels in the image at which a direction of the pixel gradient is aligned with the direction of the angular quantization bin is determined, wherein the steps are performed in a processor.

### FIELD OF THE INVENTION

This invention relates generally to computer vision, and more particularly to global descriptors for matching Manhattan scenes that can be used for viewpoint-invariant object matching.

### BACKGROUND OF THE INVENTION

Viewpoint-invariant object matching is difficult due to image distortions caused by factors such as rotation, translation, illumination, cropping and occlusion. Visual scene understanding is a well known problem in computer vision. In particular, the identification of objects in a 3D scene based on a projection onto a two-dimensional (2D) image plane poses formidable challenges.

The human visual cortex is known to rely heavily on the presence of edges at physical object boundaries for identifying individual objects within a view. Using cues from edges, texture and color, the brain is usually able to visualize and understand a three-dimensional (3D) scene irrespective of the viewpoint. In contrast, lacking a high level processing architecture, such as the visual cortex, modem computers must explicitly incorporate low-level viewpoint invariance into scene descriptors.

Methods for scene understanding include two broad classes. One class relies on local keypoints that can be accurately detected, irrespective of rotation, translation and other viewpoint changes. A descriptor is then constructed for the keypoints to capture the local structure of gradients, texture, color and other information, which remains invariant to viewpoint changes. Scale-invariant feature transform (SIFT) and speeded up robust features (SURF) are examples of two keypoint based descriptors.

Another class of methods involves capturing features at a global scope. Accuracy is obtained by local averaging and by using other statistical properties of color and gradient distributions. The global approach is employed in histogram of gradients (HOG) and GIST descriptors.

The local and global approaches have complementary features. Local descriptors are accurate and discriminative for the corresponding local keypoint, but global structural cues about larger objects are absent and can only be inferred after establishing correspondences among several local descriptors associated with the keypoints. Global descriptors tend to capture aggregate statistical information about the image but do not include specific geometric or structural cues that are often relevant for scene understanding.

Many man-made scenes satisfy a Manhattan world assumption, where lines are oriented along three principal orthogonal directions. A crucial aspect of Manhattan geometry is that all parallel lines with a dominant direction intersect at a vanishing point in a 2D image plane. In scenes where three orthogonal directions may not exist, lines can satisfy a single dominant direction, e.g., vertical or horizontal or can contain multiple dominant non-orthogonal directions, e.g., objects of furniture inside a room.

### SUMMARY OF THE INVENTION

The embodiments of the invention provide a global descriptor for Manhattan scenes. Manhattan scenes have dominant directional orientations, usually in three orthogonal directions. Thus, all parallel edges in 3D, which lie in a dominant direction, invariably intersect at a corresponding vanishing point (VP) in a 2D) image plane. All the scene edges maintain relative spatial locations and strengths as viewed from the VPs. The global descriptor is based on spatial locations and intensities of image edges in the Manhattan scenes around the vanishing point. With eight kilobits per descriptor and up to three descriptors per image (one for each VP), the method provides efficient storage and data transfer for matching compared to local keypoint descriptors such as SIFT.

A method constructs a global descriptor by strictly maintaining an angular ordering of parallel lines across images when the lines intersect at a vanishing point. The relative lengths and relative angles (orientations or directions) of the parallel lines meeting at a vanishing point are approximately the same.

A compact, global image descriptor for Manhattan scenes captures relative locations and strengths of edges along vanishing directions. To construct the descriptor, an edge map is determined for each vanishing point. The edge map encodes the edge strengths over a range of angles or directions measured for the vanishing point.

For object matching, descriptors from two scenes are compared across multiple candidate scales and displacements. The matching performance is refined by comparing edge shapes at the local maxima of the scale-displacement: plots in the form of histograms.

### BRIEF DESCRIPTION OF THE DRAWINGS

FIG. 1 is an image of a Manhattan scene including two vanishing points for which global descriptors according to embodiments of the invention are constructed;

FIG. 2 is a schematic showing the various angles subtended at a vanishing point locations with respect to a horizontal reference line, and angular quantization bins according to embodimens of the invention;

FIG. 3 is a schematic of binned pixel intensities of edge maps according to embodiments of th invention;

FIG. 4 is a schematic edge strength in angular bins for two different views of a building according to embodiments of the invention;

FIG. 5 is a flow diagram of a method for constructing global descriptors according to embodiments of the invention;

FIG. 6 is a schematic of an affine transformation for two images according to embodiments of the invention;

FIG. 7 is a histogram of edge strengths on a scale-displacement plot according to embodiments of the invention;

FIG. 8 is a flow diagram of a method for matching objects using the global descriptors according to the embodiments of the invention; and

FIG. 9 is a diagram explaining a metric for measuring the quality of the matching according to embodiments of the invention.

### DETAILED DESCRIPTION OF THE PREFERRED EMBODIMENTS

The embodiments of the invention provide a global descriptor 250 for a Manhattan scene 100. Manhattan scenes have dominant directional orientations usually in three orthogonal directions, and all parallel edges in 3D that lie in a dominant direction intersect at a corresponding vanishing point (VP 101 in a 2D image plane. It is noted that Manhattan scenes can, be indoors or outdoors and include any number of objects.

The descriptors 250 are constructed 500 from images 120 acquired by a camera 110. The descriptors can then be used for object matching 800, or other related computer vision applications. The constructing and matching can be performed in a processor 150 connected to memory and input/output interfaces by buses as known in the art.

Vanishing Point-Based image Descriptor

The descriptor is based on the following realizations about multiple images 120 (views) of the same object. First, parallel lines in the actual 3D scene strictly maintain their angular ordering across 2D images (up to an inversion) when the lines intersect at a vanishing point. Second, the relative lengths and relative angles of the parallel lines meeting at a vanishing point are approximately the same These realizations suggest that the relative locations and strengths of edges oriented along the vanishing directions can be used to construct a descriptor. We describe the steps involved in constructing 500 the descriptor 250, and using the descriptors for matching below.

Seeding Descriptors at each Vanishing Point

A vanishing point is defined as a point of intersection of projections of lines 102 that are parallel in the 3D scene, for which a 2D image 100 is available. A VP can be considered as the 2D projection of a 3D point infinitely far away in the direction given by parallel lines in the 3D scene.

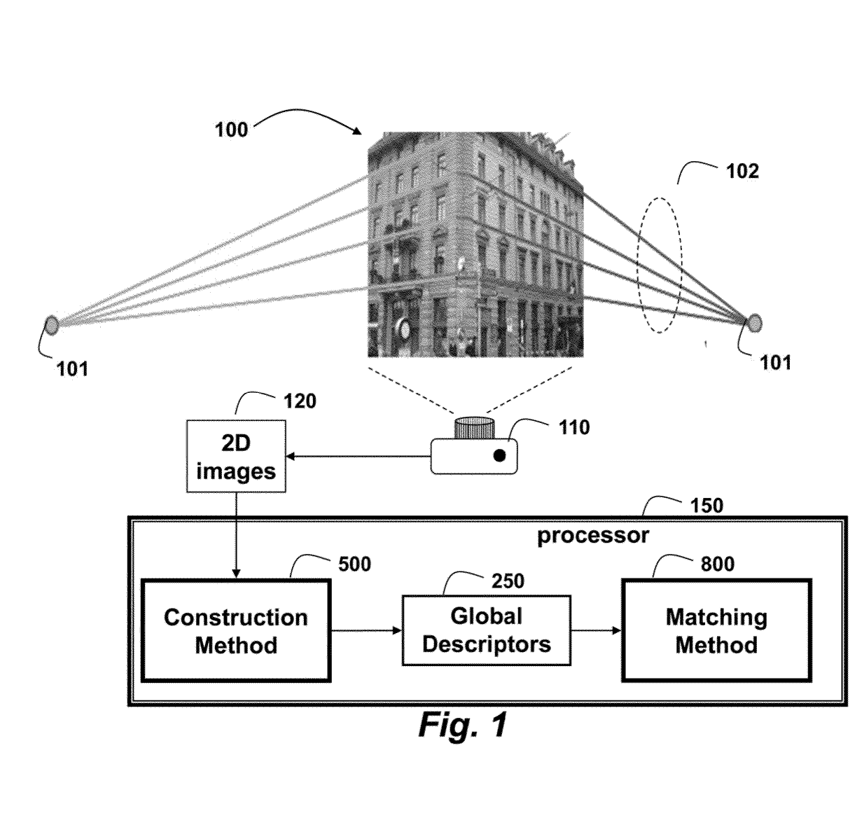

In general, there are many vanishing points corresponding to multiple scene directions determined by parallel lines. Many man-made structures, e.g., urban landscapes, however have a regular cuboid geometry. Hence, usually, three vanishing points result from an image projection, two of which are shown in FIG. 1.

VPs have been used in computer vision for image rectification, camera calibration and related problems. Identification of VPs is simple if parallel lines in the underlying 3D scene are labeled, but becomes more difficult when labeling is not available. Methods for determining vanishing points include agglomerative clustering of edges, 1D Hough transforms, multi-level RANdom SAmple Consensus (RANSAC)-based approaches and Expectation Maximization (EM) for assigning edges to VPs.

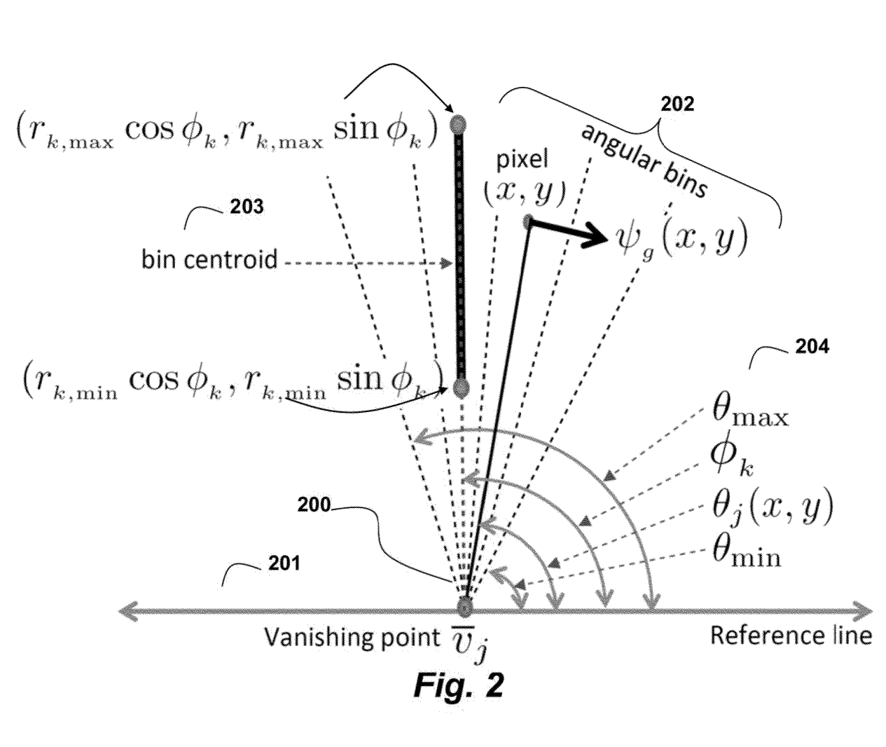

As shown in FIG. 2, VP locations 200 can be denoted by v̅ᵢ=(vᵢₓ,v_{iy}),1≦i≦m, where, typically, for Manhattan scenes, m≦3. Further, let θⱼ(x,y) be the angle subtended at the VP v̅ⱼ with respect to a horizontal reference line 201. Thus,

$${θ}_{j} ( x , y ) = {tan}^{- 1} ( \frac{y - {v}_{jy}}{x - {v}_{jx}} ) .$$

The descriptor 250 is constructed by encoding relative locations and strengths of the edges that converge at each VP. Thus, the descriptor can be considered as a function D:Θ→R⁺, whose domain includes angular orientations of the edges converging at the VP, and whose range includes a measure of the strengths of these edges in the correct order. A descriptor is determined for each VP according to the method 500 described below.

Edge Location Encoding

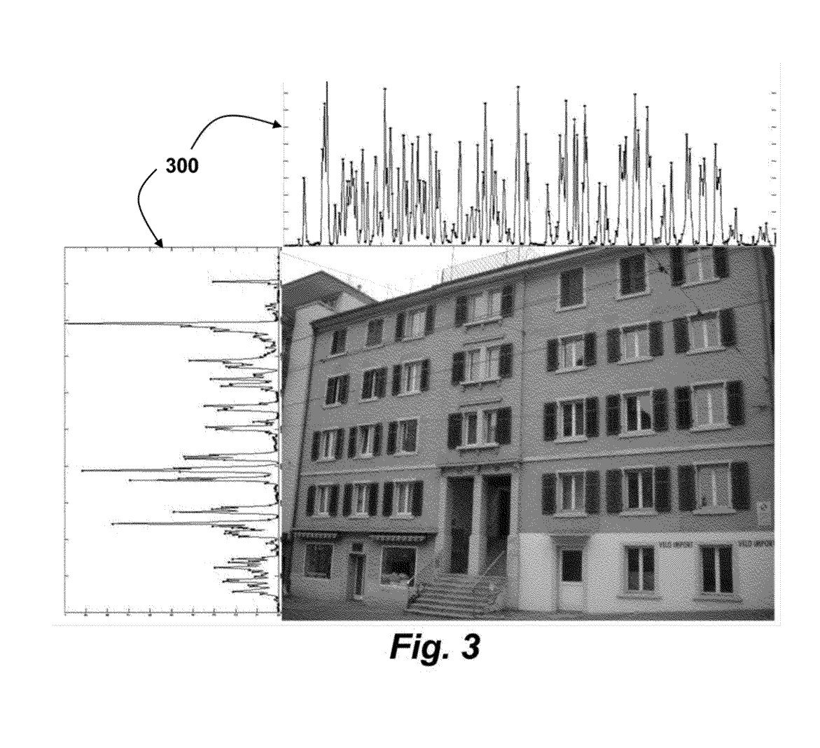

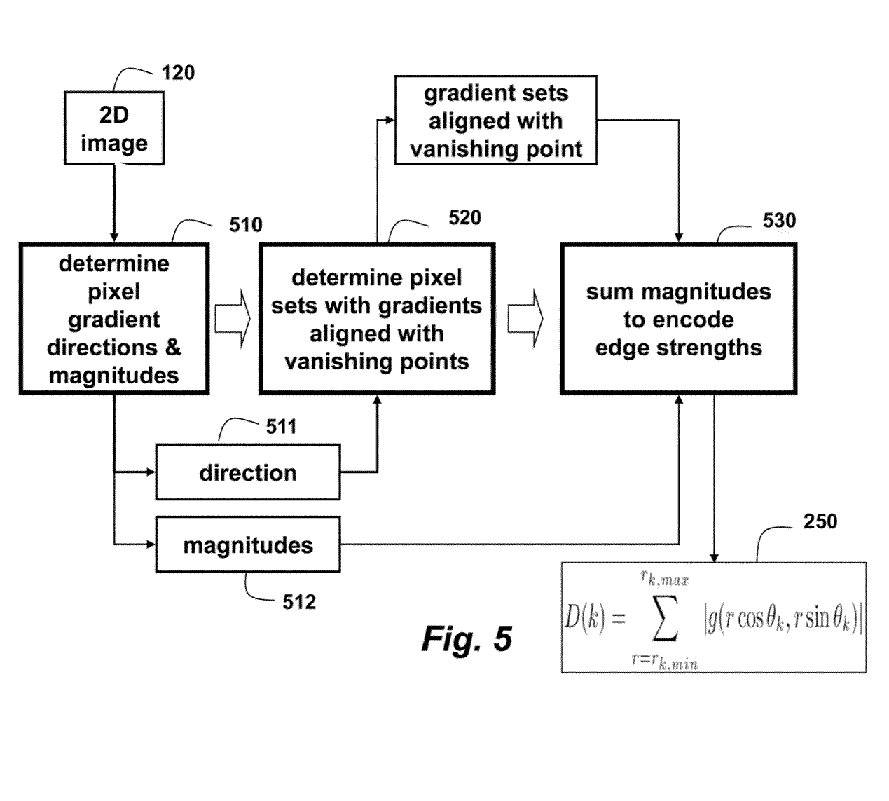

Line detection procedures often produce broken and cropped lines, miss important edges, and produce spurious lines. Therefore, as shown in FIG. 3, we work directly with intensities of edge pixels for accuracy, rather than lines that are fitted to image edges. The representations of edge strengths as a function of the angular location of the edges around the vanshing point are referred to as edge maps 300. Specifically, we store and independently sum the intensities of pixels in angular bins 202, as shown in FIG. 2, when the gradients indicate that the pixels are oriented according to the vanishing points for constructing the descriptor. To do this, as shown in FIG. 5, we first determine 510 a gradient g(x,y) , which is a 2D vector for every pixel in the image.

A direction ψ_{g}(x,y) 511 of a gradient of a pixel at a location (x, y) in the image refers to the direction along which there is a large intensity variation. A magnitude |g(x,y)| 512 of the gradient refers to the intensity difference at that pixel along the gradient direction.

Then, we determine 520 a pixel set Pⱼ for the vanishing point VP v̅ⱼ as

$${P}_{j} = \{ ( x , y ) \vert \vert {ψ}_{g} ( x , y ) - {θ}_{j} ( x , y ) - \frac{π}{2} \vert \leq τ \} ,$$

where τ is a threshold selected based on an amount by which the gradient direction is misaligned with the direction of the VP. Having determined, the set Pⱼ, the underlying edge locations are encoded as follows.

The pixel angles (directions) are quantized into a preset number (K) of uniform angular bins 202 centered 203 at φₖ,1≦k≦K, within an angular range [θmin,θmax] 204 spanning the image, such that

$${φ}_{k} = {θ}_{min} + \frac{k}{K + 1} ( {θ}_{max} - {θ}_{min} ) ,$$

1≦k≦K, so the centroid of the angular quantization bin indicates a direction of the angular quantization bin, i.e., the pixel angles.

Edge Strength Encoding

Studies on the human visual system suggest that the relative prominence of edges plays a role in visualizing a distinctive object pattern. The prominence of an image edge is a function of a length of the edge, a thickness, and a lateral variation (intensity and fall-off characteristics) in the direction perpendicular to the edge.

There are several ways to construct an edge strength metric. For example, if edge detectors are used to construct the descriptor for a particular VP, then the strength can he a function of the edge length and the pixel-wise cumulative gradient along the edge. However, as described above, using edge detectors is not always accurate. Therefore, we prefer methods based on clustering or quantization of pixel-wise gradients. The process is described in detail below.

When the pixel set Pⱼ is uniformly quantized into the angular bins 202, one way to encode the edge strength is to determine a sum of the magnitudes of the gradients |g(x,y)| 512 in each angular quantization bin. To achieve this, we consider a line segment 203 passing through the middle of every angular quantization bin with end points (r_{k,min} cos φₖ,r_{k,min} sin φₖ) and (r_{k,max} cos φ_{k,max} sin φₖ), as shown in FIG. 2.

Then, the descriptor 250 is the following summations

$$D ( k ) = {\sum }_{r = {r}_{k , min}}^{{r}_{k , max}} \vert g ( r cos {θ}_{k} , r sin {θ}_{k} ) \vert ,$$

where, φₖ,1≦k≦Kⱼ represent the angular orientations or directions associated with the quantization bins with respect to the VP v̅ⱼ, and r can vary in a range at half-pixel resolution.

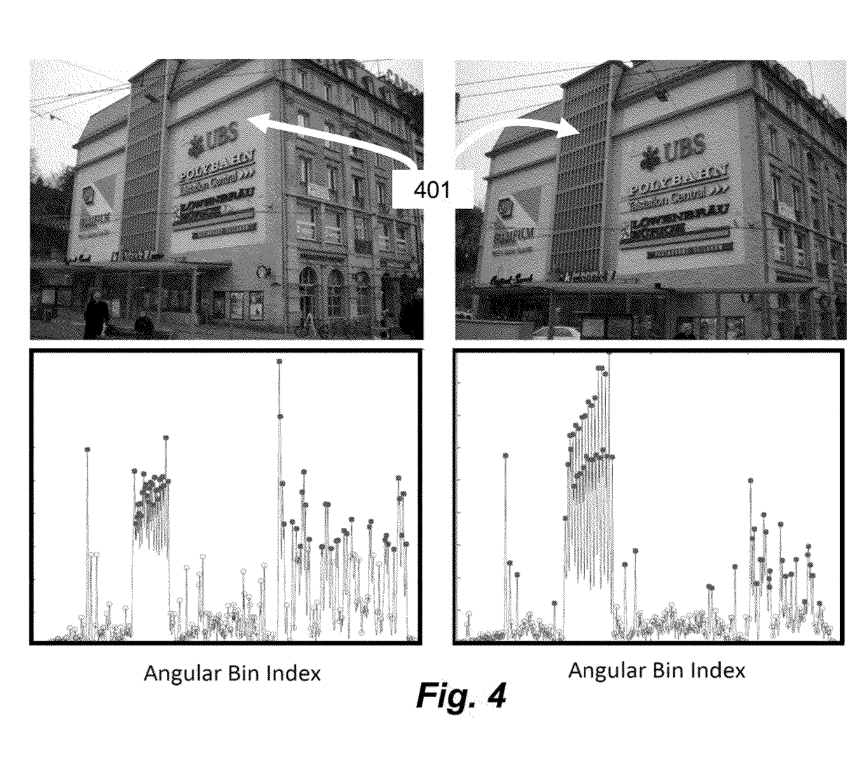

For accuracy, bilinear interpolation is used to obtain the pixel gradients at sub-pixel locations. The construction 500 of the descriptor D(k) 250 is performed at sub-pixel resolution. Examples of descriptors, obtained as above, by determining the edge strength in each angular bin, are shown in FIG. 4 for two different views of the same (building) object 401. The corresponding graphs show the normalized intensity sums as a function of the bin indices.

Construction Method

FIG. 5 summerizes the basic steps for the construction method. For each pixel in the image 120 determine a direction 511 and magnitide 512 of a gradient. Next, sets 521 of gradients with directions aligned with a vanishing points, of which there can be up to three, are determined. Then, the magnitides of gradients for each set are summed indepently and encoded 530 as edge strengths to obtain the descriptor 250 for each vanishing point.

Projective Transformation

Our motive behind constructing 500 the global descriptors 250 is to perform the matching 800 of an object in images acquired from different viewpoints. Because each image is a 2D projection of the same real-world scene, there usually exists a geometrical relationship between the corresponding keypoints is or edges in pair of images. For example, there exists a homography relationship between images of planar facades of a constructing. Our realizations suggest that there is an affine correspondence between the descriptors D(k) 250 determined for images of the same object.

Below, we describe that this realization has a theoretical justification In particular, we show that the transformation of the angles between the image lines (edges) used in the binning step while constructing 500 the descriptor, is approximately affine.

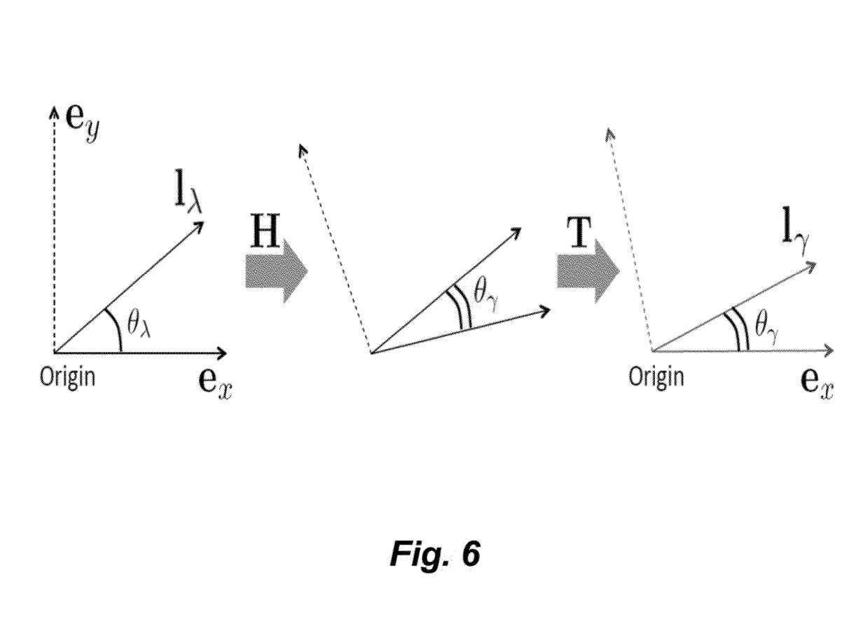

As shown in FIG. 6, considers two images (views) of the same scene consisting of a “pencil” of lines that pass through a vanishing point. Let the vanishing point for the first view be located at an origin. Using homogeneous representation, the x and y axes are given by eₓ=(010)^{T} and e_{y}=(100)^{T}, where T is a transpose operator. Using these vectors, any line l_{λ} is represented as

l_{λ=e}ₓλe_{y}=(λ10)^{T},

where λ∈R.

Without loss of generality, we assume that the inter-angle considered is the angle between the x-axis and l_{λ}. Note that θ_{λ}=ₜₐₙ^{-l}(−λ). Our goal is to show that the angle between the x-axis and l_{λ} undergoes an approximately affine transformation from one image to the other. To show this, denote the 3×3 homography between the two views using a matrix H. In general, under the homography, the vanishing point is no longer at the origin for the second view, and Heₓ is no longer along the x-axis. Now, choose a transformation given by another 3×3 matrix T that translates the vanishing point back to the origin and rotates Heₓ back to the x-axis, as shown FIG. 6.

We denote the TH transformation of l_{λ} by l_{γ}, and the angle between l_{γ} and the x-axis by θ_{γ}. Then,

l_{γ}=THl_{λ}=TH(λ10)^{T}=(a₁+λb₁a₂+λb₂0)^{T},

where,

$${θ}_{γ} = {tan}^{- 1} - \frac{{a}_{1} + λ {b}_{1}}{{a}_{2} + λ {b}_{2}}$$

in which (a₁,a₂,b₁,b₂) are the transformation parameters derived from the elements of T and H. Under the assumption that the vanishing point is far away from the image, so that θₘₐₓ−θₘᵢₙ is small, we can use a Taylor series approximation tan⁻¹(α)≈α where α is a small angle (expressed in radians). Accordingly,

$${θ}_{γ} = - \frac{{a}_{1} - {θ}_{λ} {b}_{1}}{{a}_{2} - {θ}_{λ} {b}_{2}}$$

$${a}_{2} {θ}_{γ} = - {a}_{1} + {b}_{1} {θ}_{λ} + {b}_{2} {θ}_{γ} {θ}_{λ} .$$

With the assumption of small inter-angles, the second order term θ_{γ}θ_{λ} becomes negligibly small. If we neglect this cross term, then the transformation from θ_{λ} to θ_{γ} is approximately affine.

Descriptor Matching

An object in a Manhattan scene can have up to three VP's, and thus three descriptors. Hence, matching an object seen from two viewpoints without prior orientation information involves up to nine pairwise matching operations. As described above, the angular edge locations undergo an approximate affine transform with a change in viewpoint. Therefore, we propose to invert this transformation before comparing the relative shapes of the edge strengths in the pair of descriptors being matched. The inversion step is performed using several candidate scales and displacements, i.e., several candidate affine transformations, from which the dominant affine transformation (scale-displacemen) pair can he chosen. The method 800 is used to compare descriptors as described below.

Edge-Wise Corresponding Mapping

To determine the approximate affine transform that translates the descriptor between viewpoints, we exploit the fact that under the correct: correspondence, pairs of coplanar edges generate approximately the same affine parameters, given by a scale-displacement pair (s, d). Hence, a Hough transform-type voting procedure in the (s, d) space for pairs of edges results in a local maximum at the true scale s* and displacement d*.

Multiple local maxima occur when the object has multiple planes supported by the VP directional axis. For accuracy and efficiency, prominent edges are identified based on their edge strength. Pixels on edges with strength greater than a specified percentile threshold are selected. Furthermore, for accuracy to edge occlusion, only edges within close angular proximity are paired to cast votes, e.g., each prominent edge is paired with the C closest edges.

The descriptor D₁(k),1≦k≦K can generate a set of N₁ peak pairs (kᵢ,k′ᵢ),1≦i≦N₁. Similarly, D₂(m) generates a set of N₂ peak pairs (mⱼ,m′ⱼ),1≦j≦N₂. The identified pairs of peaks are cross-mapped between the two sets to generate votes for the (s,d) histogram using

$$s = \frac{{m}_{j}^{′} - {m}_{j}}{{k}_{i}^{′} - {k}_{i}}$$

and d=mⱼ−skᵢ. To allow for angular inversion, i.e., top/bottom and left/right rotation around the VP, additional votes are generated by reversing the ordering of peaks within one of the above two sets.

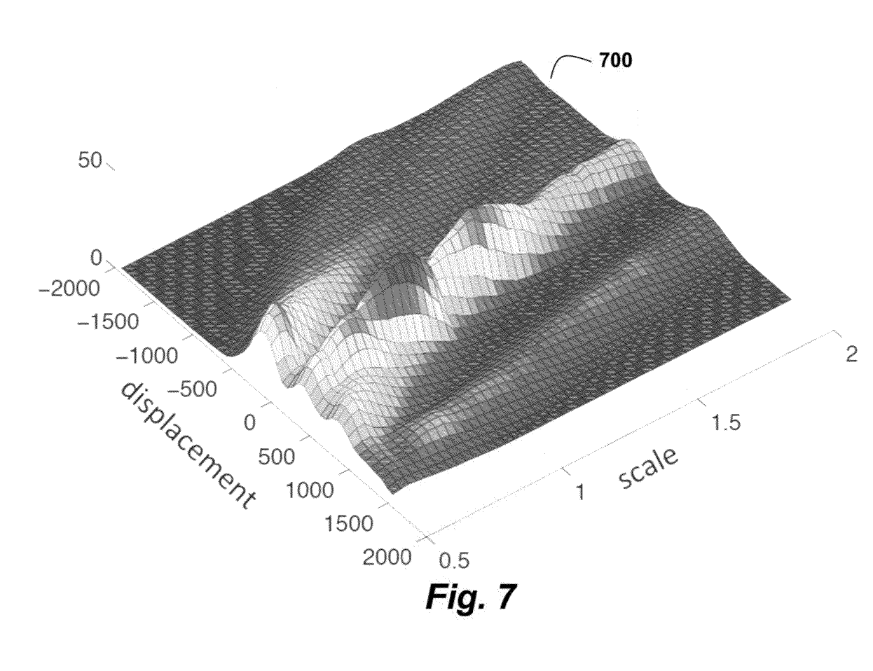

As shown in FIG. 7, a coarse histogram 700 of the (s,d) votes can now be used to locate local maxima (s*,d*). The histogram identifies the scale and displacement at which two VP-based descriptors have a best match. The local maxima provide a relation between edges in the two views of the object. If a local maximum contains too few votes, then a non-match is declared for that (s*,d*) pair. If none of the local maxima contain enough votes, then that the descriptors do not represent the same object.

Therefore, each descriptor is modified such that the scale and the displacement of the descriptors are identical. Then, a difference between the shapes of peaks in the first descriptor and the corresponding peaks in the second descriptor is determined, and a match between the two images can be indicated when this difference is less than a threshold.

Matching Method

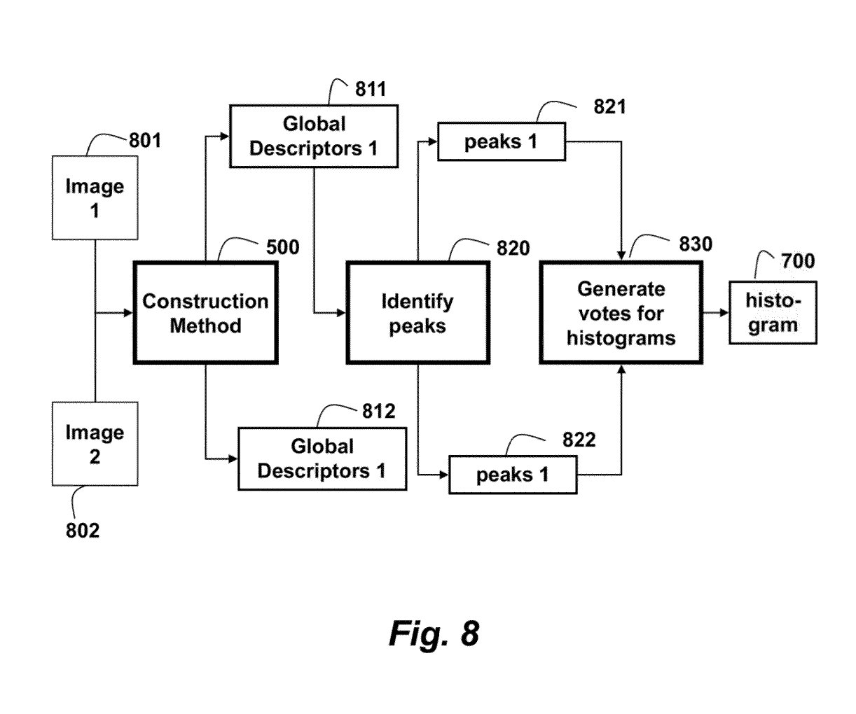

FIG. 8 summarizes the basic steps for the matching method 800. For images 801 and 802, respective descriptors 811 and 812 are constructed 500 as described above. Peaks 821 and 82.2 are identified 820, and votes for the histogram 700 are generated 830. The peaks identify the scale and displacement at which two VP-based descriptors have the best match.

It should also be noted that the descriptors can be used as queries into a database of image to retrieve images of scene that are similar.

Shape Matching at Corresponding Edges

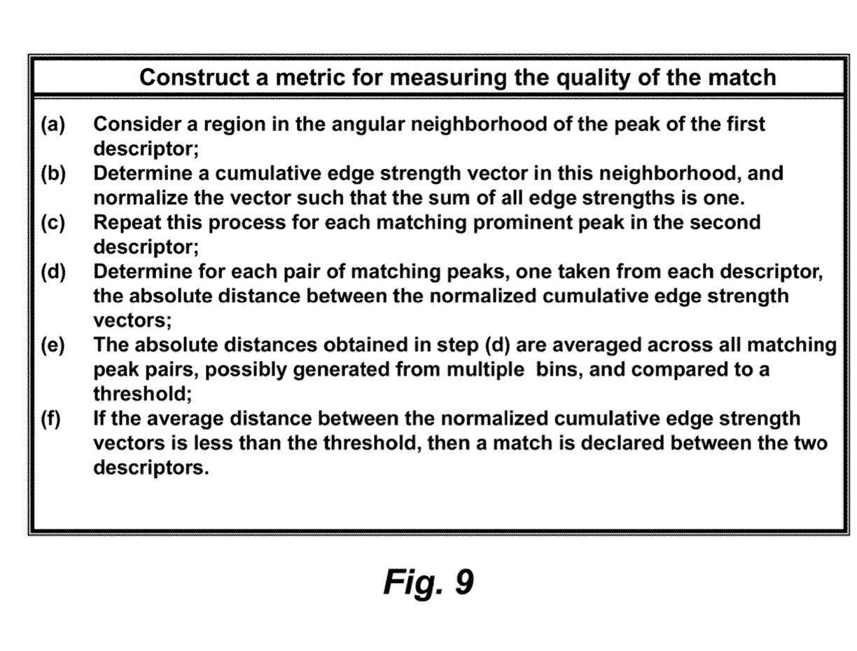

At each local maxima (s*,d*), the local shape of the edge strength plot in the two descriptors being compared, e.g., the plots in FIG. 4, can be exploited to refine the matching process. Essentially, after compensating for the scaling factor s* and the displacement d*, it remains to compare the shapes of the edge strength plots in the neighborhood of the edge pairs that voted for (s*,d*). There are several ways to do this. We describe one embodiment below.
a) As shown in FIG. 9, to construct a metric for measuring the quality of the match, we perform the following steps for each prominent peak:
b) Consider a region in the angular neighborhood of the peak of the first descriptor;
c) Determine a cumulative edge strength vector in this neighborhood, and normalize the vector such that the sum of all edge strengths is one.
d) Repeat this process for each matching prominent peak in the second descriptor;
e) Determine for each pair of matching peaks, one taken, from each descriptor, the absolute distance between the normalized cumulative edge strength vectors;
f) The absolute distances obtained in step (d) are averaged across all matching peak pairs, possibly generated from multiple bins, and compared to a threshold;
g) If the average distance between the normalized cumulative edge strength vectors is less than the threshold, then a match is declared between the two descriptors.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method fir constructing a descriptor for an image of a scene, wherein the descriptor is associated with a vanishing point in the image, comprising the steps of:
quantizing an angular region around the vanishing point into a preset number of angular quantization bins, wherein a centroid of each angular quantization bin indicates a direction of the angular quantization bin;
determining, for each angular quantization bin, a sum of magnitudes of pixel gradients for pixels in the image and a direction of the pixel gradient that is aligned with the direction of the angular quantization bin, wherein the steps are performed in a processor.

2. The method of claim 1, wherein the scene is a Manhattan scene with Manhattan world assumptions.

3. The method of claim 1, herein the angular quantization bins are uniform.

4. The method of claim 1, wherein the angular quantization bins are determined by clustering of the directions of the pixel gradients, wherein the directions are measured with respect to a location of the vanishing point.

5. The method of claim 1, wherein the pixel gradients are determined independently at each pixel.

6. The method of claim 1, wherein the pixel gradients are performing edge detection on the image to determine edge strengths, and determining the pixel gradients only for the pixels with edge strengths greater than a specified percentile threshold as peaks.

7. The method of claim 1, wherein the clients are determined at sub-pixel locations.

8. The method of claim 1, further comprising:
comparing first and second descriptors constructed from two images acquired of the scene from different viewpoints.

9. The method of claim 8, further comprising:
constructing a metric for measuring a quality of the matching.

10. The method of claim 8, further comprising:
identifying from the descriptor of each image, the pixels with edge strengths greater than a specified percentile threshold as peaks.
generating a scale-displacement plot, such that a pair of peaks chosen from the first descriptor, cross-mapped according to a given scale and displacement value correspond to a pair of peaks chosen from the second descriptor;
identifying one or more local maxima in the scale-displacement plot; and
comparing the two descriptors using the scale and displacement values at each local maximum.

11. The method of claim 10, wherein the comparing further comprises
modifying each descriptors such that the scale and the displacement of the descriptors are identical.
determining the difference between the peaks in the first descriptor and the peaks in the second descriptor: and
declaring a match between the two images when the difference is below a threshold.

12. The method of claim 11, in which the determining of the difference further comprises:
calculating, for the corresponding peaks in the first descriptor and second descriptor, a cumulative edge strength in an angular neighborhood of the peaks;
normalizing the cumulative edge strengths such that a sum of the edge strengths in the angular neighborhood of the peak is one; and
computing a distance between the normalized cumulative edge strengths or the first descriptor and second descriptor.

13. The method of claim 1, further comprising:
retrieving similar images from a database of images based on the descriptors.

14. The method of claim 1, wherein the pixel set for the vanishing point is
$${P}_{j} = \{ ( x , y ) \vert \vert {ψ}_{g} ( x , y ) - {θ}_{j} ( x , y ) - \frac{π}{2} \vert \leq τ \} ,$$
where the direction of the gradient of a pixel at a location (x,y) in the image is ψ_{g}(x,y), θⱼ(x,y) is an angle subtended at the vanishing point with respect to a horizontal reference line, and τ is a threshold selected based on an amount by which the direction that is misaligned with the direction of the vanishing point

15. The method of claim 1, further comprising:
quantizing the directions into a predetermined number (K) or bins centered at φₖ,1≦k≦K, within an angular range [θₘᵢₙ,θₘₐₓ], such that
$${φ}_{k} = {θ}_{min} + \frac{k}{K + 1} ( {θ}_{max} - {θ}_{min} ) , 1 \leq k \leq K .$$

16. The method of claim 15, wherein the descriptor is
$$D ( k ) = {\sum }_{r = {r}_{k , min}}^{{r}_{k , max}} \vert g ( r cos {θ}_{k} , r sin {θ}_{k} ) \vert ,$$
where, θₖ,1≦k≦Kⱼ represent the directions of the bins, and r varies in a range at half-pixel resolution.
